(19) United States
(12) Patent Application Publication
(10) Pub. No.: US 2024/0399913 A1
(43) Pub. Date: Dec. 5, 2024

(54) Charger

(71) Applicant: EGTRONICS Co., Ltd., Hwaseong-Si (KR)

(72) Inventors: Chan-Ho Kang, Hwaseong-Si (KR); Young-Gun Hong, Goyang-Si (KR); Ui-Soung Park, Daejeon (KR); Ko Choi, Seoul (KR); Su-Kang Lee, Incheon (KR)

(21) Appl. No.: 18/679,910

(22) Filed: May 31, 2024

(30) Foreign Application Priority Data
Jun. 1, 2023 (KR) 10-2023-0070833

(51) Int. Cl. B60L 53/62; H02J 7/00

(52) U.S. Cl. CPC B60L 53/62; H02J 7/0047; H02J 7/00711; H02J 7/00712

(57) ABSTRACT

The present disclosure relates to a charger for preventing problems that may occur in a charger, an electric vehicle, and a charging infrastructure without interrupting charging of the charger when a voltage input to the charger is a low voltage, and includes a sensing unit provided at the charger, configured to sense an input voltage input to the charger; and a controller provided at the charger, configured to perform a first monitoring mode in which the charger is controlled to reduce current flowing to the electric vehicle when the input voltage sensed at the sensing unit is lower than a reference value which is lower than a rated voltage by a preset magnitude.

### CROSS-REFERENCE TO RELATED APPLICATION(S)

This application is based on and claims priority of Korean Patent Application No. 10-2023-0070833, filed on Jun. 1, 2023 with the Korean Intellectual Property Office, the entire contents of which are hereby incorporated by reference.

### TECHNICAL FIELD

The present disclosure relates to a charger, and more specifically, to a charger configured to prevent a charging operation of the charger from being interrupted in a low voltage state in which a voltage input to the charger is low.

### BACKGROUND

In recent years, electric vehicles have gained popularity for environmental reasons. In the early 2010s, technology of electric vehicles was in its early stage, and the performance and travel distance of electric vehicles were not sufficient. However, advances in battery and motor technology have led to improvements in the performance and driving range of electric vehicles over time, resulting in an increasing number of electric vehicle models.

As electric vehicles become more prevalent, charging infrastructure is also becoming more widespread. Charging of electric vehicles can be broadly divided into fast charging and slow charging. In Korea, the slow charging system is mainly provided in shared housings and is used to charge electric vehicles over a long period of time.

In general, the charger receives power from a separate voltage source, and based on this, supplies current to an electric vehicle to charge the electric vehicle. Generally, the fast charger receives power from a separate voltage source, but the slow charger receives power by being connected to a system. Since the fast charger receives power from the separate voltage source, the power input to the charger does not often become a low voltage, but since the slow charger is connected to the system, a lower voltage instead of a rated voltage of 220V may be input. If a voltage lower than a reference value which is lower than the rated voltage of 220V by a certain magnitude is input to the charger, unpredictable problems may occur for the electric vehicle, the charger, and the charging infrastructure. Therefore, when the voltage lower than the reference value is input to the charger, the charger generally operates in a way of interrupting charging of the electric vehicle. Such operation of the charger may cause dissatisfaction of users willing to charge the electric vehicles, and the overall charging efficiency of the charger is greatly reduced.

### SUMMARY

The present disclosure was devised to solve the problems described above, and the purpose of a charger according to an embodiment of the present disclosure is to prevent problems that may occur in a charger, an electric vehicle, and a charging infrastructure without interrupting charging of the charger when a voltage input to the charger is a low voltage.

According to an embodiment of the present disclosure, a charger for charging an electric vehicle may be provided, including a sensing unit provided at the charger, configured to sense an input voltage input to the charger; and a controller provided at the charger, configured to perform a first monitoring mode in which the charger is controlled to reduce current flowing to the electric vehicle when the input voltage sensed at the sensing unit is lower than a reference value which is lower than a rated voltage by a preset magnitude; wherein the controller determines whether the input voltage is lower than the reference value after a predetermined time elapses from a time point of reducing the current, and if the input voltage is lower than the reference value, performs a second monitoring mode to further reduce the current, wherein the second monitoring mode is performed repeatedly, and magnitude of the current reduced by the second monitoring mode has a lower limit.

Further, the charger may be provided, wherein the controller controls magnitude of the current flowing to the electric vehicle by a pulse width modulation (PWM) method.

Further, the charger may be provided, wherein the controller increases the current if the input voltage increases to a range which is equal to or lower than the rated voltage exceeding the reference value after a predetermined time has elapsed from the time point of reducing the current.

Further, the charger may be provided, wherein the sensing unit further includes a voltage sensor for sensing the magnitude of the input voltage, in which a Schmitt trigger circuit is applied.

Further, the charger may be provided, wherein the controller increases the current after a predetermined time has elapsed from the time point of which the input voltage has increased to a range which is equal to or lower than the rated voltage exceeding the reference value, if the input voltage rises to the range which is equal to or lower than the rated voltage exceeding the reference value after the time point of reducing the current.

Further, the charger may be provided, wherein an increased value of the current is identical to a reduced value of the current.

Further, the charger may be provided, wherein an increased value of the current is lower than a reduced value of the current, and the controller increases the current at least two times during the predetermined time.

The charger according to the various embodiments of the present disclosure can prevent shortening of life time of the charger, damage, damage to an electric vehicle, and other problems when an input voltage of the charger is lower than the reference value which is lower than the rated voltage by a preset magnitude.

### BRIEF DESCRIPTION OF DRAWINGS

FIG. 1 is a schematic diagram of a charger according to a first example of the present disclosure.

FIG. 2 is a flowchart illustrating a method of controlling the charger according to the first example of the present disclosure.

FIGS. 3A and 3B illustrate an input voltage and a charging current of the charger when a first monitoring mode and a second monitoring mode are performed in the charger according to the first example of the present disclosure.

FIG. 4 illustrates an input voltage and a charging current of a charger when the first monitoring mode and the second monitoring mode are performed in a charger according to a second example of the present disclosure.

FIG. 5 illustrates an input voltage and a charging current of a charger when the first monitoring mode and the second monitoring mode are performed in a charger according to a third example of the present disclosure.

### DETAILED DESCRIPTION

The object, features, and advantages of the present disclosure will become more apparent with the following embodiments related to the attached drawings. The following specific structural or functional descriptions are exemplified for the purpose of illustrating embodiments in accordance with the concepts of the present disclosure only, and embodiments in accordance with the concepts of the present disclosure may be implemented in various forms and should not be construed as limiting to the embodiments described herein or in the application. Since the embodiments according to the concepts of the present disclosure are subject to various modifications and may take many forms, certain embodiments are to be illustrated in the drawings and described in detail in the present specification or application. However, this is not intended to limit the embodiments according to the concepts of the present disclosure to any particular disclosed form, and is to be understood to include all modifications, equivalents, or substitutions that fall within the scope of the ideas and techniques of the present disclosure. Terms such as first and/or second may be used to describe various components, but the components are not limited to the terms. The above terms are used solely for the purpose of distinguishing one component from another, e.g. a first component may be named a second component, and similarly a second component may be named a first component, without departing from the scope of the rights in accordance with the concept of the disclosure. When a component is referred to as coupled to or connected to another component, it should be understood that it may be directly coupled to or connected to that other component, but there may be other components in between. On the other hand, when a component is said to be directly coupled to or connected to another component, it should be understood that there is no other component in between other expressions to describe the relationship between components, such as between ˜ and directly between ˜ or adjacent to ˜ and directly adjacent to ˜, should be interpreted similarly. The terms used herein is intended to describe particular embodiments only and is not intended to limit the present disclosure. Singular expressions include plural expressions unless context clearly indicates otherwise. Terms used in the present disclosure such as include or comprise are intended to designate the presence of the features, numbers, steps, operations, components, parts, or combinations thereof described, and are not intended to preclude the presence or addition of one or more other features, numbers, steps, operations, components, parts, or combinations thereof. Unless otherwise defined, all terms used herein, including technical or scientific terms, have the same meaning as commonly understood by a person of ordinary skill in the technical field to which the present disclosure belongs. Terms such as those defined in commonly used dictionaries shall be construed to have meanings consistent with their meaning in the context of the relevant art and shall not be construed to have an idealized or unduly formal meaning unless expressly defined in this specification. Hereinafter, the present disclosure will be described in detail by describing the preferred embodiments of the present disclosure with reference to the attached drawings. The same reference numerals shown in each drawing refer to the same elements.

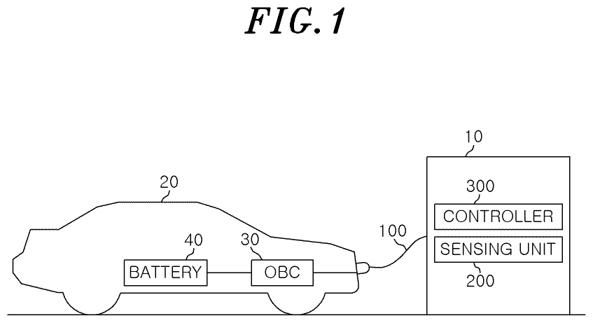

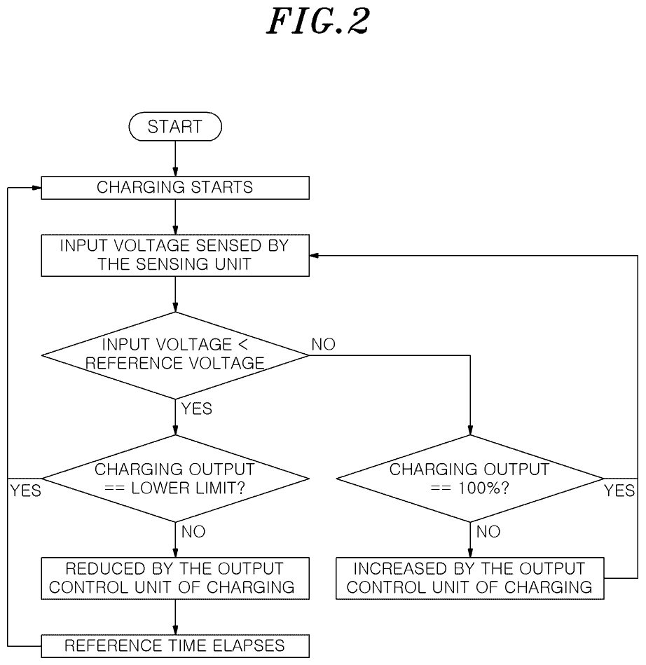

FIG. 1 is a schematic diagram of a charger according to a first example of the present disclosure, and FIG. 2 is a flowchart illustrating a method of controlling the charger according to the first example of the present disclosure.

As shown in FIG. 1, the charger according to the first example of the present disclosure is a charger 10 configured to be able to charge an electric vehicle 20, and may include a sensing unit 200 and a controller 300. The charger 10 is connected to the electric vehicle 20 through a control pilot (CP) line 100, and a charging current flows from the charger 10 to the electric vehicle 20. An on board charger (OBC) 30 mounted on the electric vehicle 20 charges a battery 40 through the charging current flowing from the charger 10.

The sensing unit 200 is provided at the charger 10 and senses an input voltage which is input to the charger 10. The charger 10 shown in FIG. 1 may be one of a slow charger and a fast charger. If the charger 10 is the slow charger, the charger 10 can receive voltage input from a system, and if the charger 10 is the fast charger, the charger can receive voltage input from a separate generator. The present example describes a case in which the charger 10 is the slow charger.

The sensing unit 200 may include a voltage sensor in which a Schmitt trigger circuit is applied to sense an input voltage input to the charger 10.

The Schmitt trigger is a functional logic gate used in electronic circuits. The Schmitt trigger has strong stability against noise or fluctuations of an input signal and operates using a discrete input signal. The voltage sensor with the Schmitt trigger applied has a characteristic that when the input signal exceeds a threshold, an output switches to a specific state, and regardless of the previous input signal, the output reacts directly to the magnitude of the input signal, and can operate stably even in the presence of noise or fluctuation.

There may be several methods of applying the Schmitt trigger circuit to the voltage sensor. When describing a general circuit to which the Schmitt trigger is applied, the Schmitt trigger receives the output signal of the voltage sensor as an input and defines a threshold to compare the voltage level when the input signal rises and falls based on the threshold. Given the output of the voltage sensor as the input of the Schmitt trigger, the Schmitt trigger converts an analog signal into a digital signal and processes it by switching the output to high (or 1) when the voltage of the input signal exceeds a high threshold, and to low (or 0) below a low threshold.

The controller 300, as shown in FIG. 2, controls operation of the charger according to the first example of the present disclosure.

First, when the input voltage of the charger 10 is sensed at the sensing unit 200, the controller 300 receives the input voltage of the charger 10 from the sensing unit 200. The controller 300 performs a first monitoring mode in which the charger 10 is controlled to reduce the current flowing to the electric vehicle 20 when the input voltage of the charger 10 is lower than a reference value which is lower than a rated voltage by a preset magnitude Here, the controller 300 can reduce the current flowing to the charging electric vehicle 20 by a pulse width modulation (PWM) method, and the reduction value can be preset. The present disclosure, as described above, can reduce the charging current even if the input voltage of the charger 10 is low through the first monitoring mode, to prevent a problem that may occur in the charger 10 without interrupting the charging of the electric vehicle 20 by the charger 10.

The controller 300 determines whether the input voltage of the charger 10 is still lower than the reference value after a predetermined time has elapsed from the time point of reducing the current. If the input voltage is still lower than the reference value, a second monitoring mode is performed to additionally reduce the current flowing toward the electric vehicle 20. The second monitoring mode may be repeatedly performed, but the current may have a lower limit set, and the controller 300 does not reduce the current to or below the lower limit of the current. That is, the magnitude of the current reduced by the second monitoring mode may have a lower limit.

When the second monitoring mode is repeatedly performed, the charging current flowing from the charger 10 to the electric vehicle 20 is set to the lower limit, and if the condition for the second monitoring mode to be performed is satisfied even after the lower limit is set, a message including status information of the charger 10 may be transmitted to a pre-stored contact to notify the abnormality of the charger 10. Here, the pre-stored contact may be at least one of an operating entity of the charger according to the present disclosure and an owner of the electric vehicle 20.

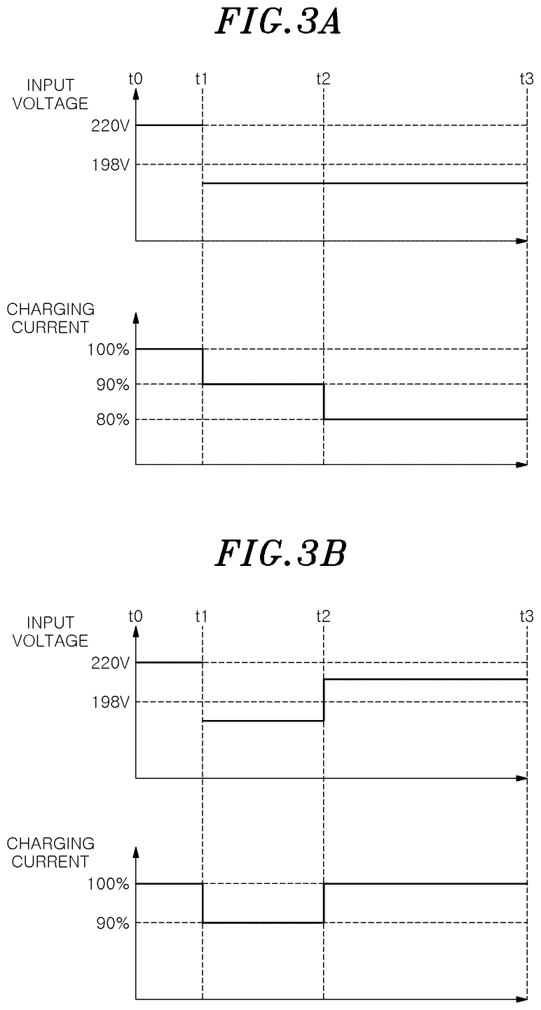

FIGS. 3A and 3B illustrate an input voltage and a charging current of the charger 10 when the first monitoring mode and the second monitoring mode are performed by the charger according to the first example of the present disclosure.

As shown in FIG. 3A, the rated voltage in a normal state (interval between t0 and t1) as the input voltage may be 220V, and when the rated voltage is input to the charger 10, the controller 300 supplies 100% of the set charging current to the electric vehicle 20. Thereafter, as shown in an interval between t1 and t2, when the input voltage of the charger 10 drops below 198V which is 10% reduced from the rated voltage, the controller 300 supplies 90% of the current flowing from the charger 10 to the electric vehicle 20, which is 10% reduced. The controller 300 determines whether the voltage input to the charger 10 exceeds 198V when a predetermined time (e.g., 30 minutes) has elapsed from the time point of reducing the current flowing to the electric vehicle 20 by 10% through controlling the charger 10. If the voltage input to charger 10 is still less than 198 V as shown in an interval between t2 and t3 in FIG. 3A, the controller 300 performs the second monitoring mode which reduces the current flowing to the electric vehicle 20 by an additional 10%. The second monitoring mode may be performed repeatedly, but the current flowing to the electric vehicle 20 is determined to have a lower limit such as 70%, so the controller 300 does not reduce the current flowing to the electric vehicle 20 beyond the limit.

On the other hand, in FIG. 3B, an interval between t0 and t1 and an interval between t1 and t2 are the same as in FIG. 3A, but an interval between t2 and t3 is different. More specifically, as shown in FIG. 3B, if the input voltage to the charger 10 becomes 198V or more in the interval between t2 and t3, the controller 300 may control the charger 10 to restore the magnitude of the current flowing toward the electric vehicle 20.

When describing the first monitoring mode and the second monitoring mode with reference to FIGS. 3A and 3B, the magnitude of the current that decreases and increases is described in units of 10%. However, the present disclosure does not limit the control unit of the current to 10%, and the control unit of the current can be varied according to necessity.

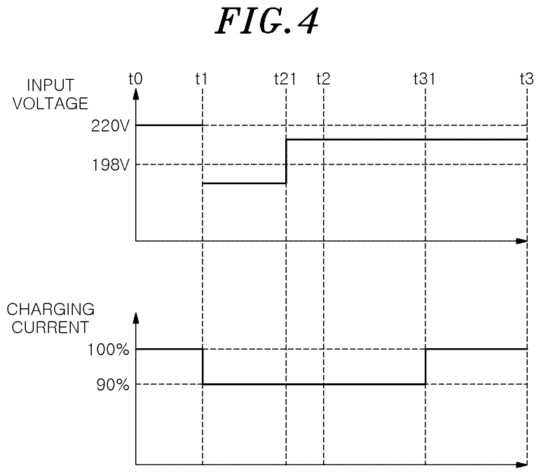

FIG. 4 shows an input voltage and a charging current of a charger 10 when the first monitoring mode and the second monitoring mode are performed in a charger according to a second example of the present disclosure.

As shown in FIG. 4 the rated voltage of the charger 10 in a normal state (interval between t0 and t1) as the input voltage may be 220V, and when the rated voltage is input to the charger 10, the controller 300 supplies 100% of the set charging current to the electric vehicle 20. Thereafter, as in the interval between t1 and t2, when the input voltage of the charger 10 drops below 198V which is 10% reduced from the rated voltage, the controller 300 supplies 90% of the current flowing from the charger 10 to the electric vehicle 20, which is 10% reduced. Thereafter, if the input voltage to the charger 10 increases to 198V or more at the time point t21 of the interval between t2 and t3, the controller 300 does not restore the current flowing toward the electric vehicle 20 at the time point t21 or t2 and maintains the magnitude of the current at 90% until time point t31 at which a predetermined time has elapsed from the time point t21. If the magnitude of the current is maintained at or above 198V at the time point t31, the controller 300 may increase the magnitude of the current flowing toward the electric vehicle 20 to 100%. This is to check whether the system or other power supply that inputs voltage to the charger 10 is stable. If the input voltage of charger 10 is reduced to 198V again in the interval between t21 and t31, the controller 300 can control the charger 10 to further reduce the magnitude of the current flowing to electric vehicle 20 from 90% to 80% at the time point t31.

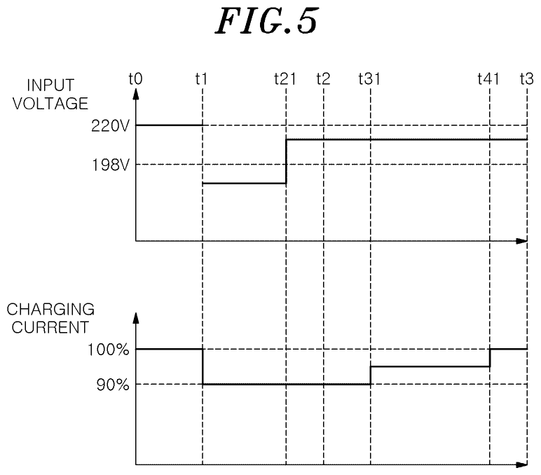

FIG. 5 illustrates an input voltage and a charging current of a charger when the first monitoring mode and the second monitoring mode are performed in a charger according to a third example of the present disclosure.

As shown in FIG. 5, an interval between t0 and t1 and an interval between t1 and t2 are identical to the charger according to the first and second examples of the present disclosure described above, and therefore a detailed description is omitted.

As shown in FIG. 5, if the input voltage to the charger 10 increases to 198V or more at the time point t21, the controller 300 maintains the magnitude of the current flowing toward the electric vehicle 20 from the time point t21 to t31 at 90%. The controller 300 restores the magnitude of the charging current to 95% instead of 100% at the time point t31, and restores the magnitude of the charging current to 100% at a time point t41 at which a predetermined time has elapsed from the time point t31. Thus, the charger according to the third example of the present disclosure restores the magnitude of the charging current in a step-wise manner. This is to respond more stably to sudden changes in the magnitude of the voltage input to the charger 10 caused by various factors.

The following is a list of examples of the present disclosure.

Item 1 is a charger for charging an electric vehicle, including a sensing unit provided at the charger, configured to sense an input voltage input to the charger; and a controller provided at the charger, configured to perform a first monitoring mode in which the charger is controlled to reduce current flowing to the electric vehicle when the input voltage sensed at the sensing unit is lower than a reference value which is lower than a rated voltage by a preset magnitude; wherein the controller determines whether the input voltage is lower than the reference value after a predetermined time elapses from a time point of reducing the current, and if the input voltage is lower than the reference value, performs a second monitoring mode to further reduce the current, wherein the second monitoring mode is performed repeatedly, and magnitude of the current reduced by the second monitoring mode has a lower limit.

Item 2 is the charger of item 1, wherein the controller controls magnitude of the current flowing to the electric vehicle by a pulse width modulation (PWM) method.

Item 3 is the charger of items 1 and 2 wherein the controller increases the current if the input voltage increases to a range which is equal to or lower than the rated voltage exceeding the reference value after a predetermined time has elapsed from the time point of reducing the current.

Item 4 is the charger of items 1 to 3, wherein the sensing unit further includes a voltage sensor for sensing the magnitude of the input voltage, in which a Schmitt trigger circuit is applied.

Item 5 is the charger of items 1 to 4, wherein the controller increases the current after a predetermined time has elapsed from the time point of which the input voltage has increased to a range which is equal to or lower than the rated voltage exceeding the reference value, if the input voltage rises to the range which is equal to or lower than the rated voltage exceeding the reference value after the time point of reducing the current.

Item 6 is the charger of items 1 to 5, wherein an increased value of the current is identical to a reduced value of the current.

Item 7 is the charger of items 1 to 6, wherein an increased value of the current is lower than a reduced value of the current, and the controller increases the current at least two times during the predetermined time.

While preferred embodiments of the present disclosure have been described above, the embodiments disclosed herein are intended to illustrate and not to limit the technical ideas of the present disclosure. Therefore, the technical idea of the present disclosure includes not only each disclosed embodiment, but also a combination of the disclosed embodiments, and furthermore, the scope of the technical idea of the present disclosure is not limited by these embodiments. Further, those skilled in the art to which the present disclosure belongs may make many changes and modifications to the disclosure without departing from the spirit and scope of the appended claims, and all such appropriate changes and modifications should be considered as equivalents and as falling within the scope of the invention.

What is claimed is:

1. A charger for charging at least one electric vehicle, the charger comprising:
a sensor provided at the charger and configured to sense an input voltage input to the charger; and
a controller provided at the charger and configured to perform a first monitoring mode in which the charger is controlled to reduce current flowing to an electric vehicle when the input voltage sensed at the sensor is lower than a reference value which is lower than a rated voltage by a preset magnitude,
wherein the controller is configured to determine whether the input voltage is lower than the reference value after a predetermined time elapses from a time point of reducing the current, and perform, based on the input voltage being lower than the reference value, a second monitoring mode to further reduce the current,
wherein the second monitoring mode is performed repeatedly, and
wherein magnitude of the current reduced by the second monitoring mode has a lower limit.

2. The charger of claim 1, wherein the controller is configured to control magnitude of the current flowing to the electric vehicle by a pulse width modulation (PWM).

3. The charger of claim 1, wherein the controller is configured to increase the current based on the input voltage being increased to a range, which is equal to or lower than the rated voltage exceeding the reference value, after a predetermined time has elapsed from the time point of reducing the current.

4. The charger of claim 1, wherein the sensor further comprises a voltage sensor for sensing the magnitude of the input voltage, in which a Schmitt trigger circuit is applied.

5. The charger of claim 1, wherein the controller is configured to increase the current after a predetermined time has elapsed from the time point of which the input voltage has increased to a range, which is equal to or lower than the rated voltage exceeding the reference value, based on the input voltage reaching the range, which is equal to or lower than the rated voltage exceeding the reference value, after the time point of reducing the current.

6. The charger of claim 5, wherein an increased value of the current is identical to a reduced value of the current.

7. The charger of claim 5, wherein an increased value of the current is lower than a reduced value of the current, and the controller is configured to increase the current at least two times during the predetermined time.
